(19) United States
(12) Patent Application Publication
(10) Pub. No.: US 2026/0065461 A1
(43) Pub. Date: Mar. 5, 2026

(54) PACKAGING PROCESS MONITORING SYSTEM AND METHOD OF MONITORING PACKAGING PROCESS

(71) Applicant: NANYA TECHNOLOGY CORPORATION, New Taipei City (TW)

(72) Inventor: Chia-Lin TSAI, New Taipei City (TW)

(21) Appl. No.: 18/822,456

(22) Filed: Sep. 2, 2024

(51) Int. Cl. G06T 7/00

(52) U.S. Cl. CPC G06T 7/001

(57) ABSTRACT

The present disclosure provides a method of monitoring a package process. The method includes: placing a material into a material box; printing a barcode on a first tag and a second tag; posting the first tag on the material box; capturing a first image of the first tag including the barcode; packaging the material box by a barrier bag; posting the second tag on the barrier bag; capturing a second image of the second tag including the barcode; identifying the first image and the second image; and issuing an alarm if at least one of the first image and the second image is identified as unreadable.

### BACKGROUND

### Field of Invention

The present invention relates to a packaging process monitoring system and a method of monitoring the packaging process.

### Description of Related Art

After wafers undergo manufacturing, yield testing, and pre-shipment appearance inspection, they are shipped to foundries or client wafer sales based on needs of products. During wafer packaging, the corresponding customers' labels and information are printed and affixed to a wafer transport box (e.g., front opening ship box (FOSB)) and a barrier bag for identification. The factory has now introduced a fully automatic wafer packaging process. However, during the packaging process, the labels printed and affixed are divided into inner labels (affixed on the wafer transport box) and outer labels (affixed on the barrier bag). After the packaging process is completed, production line personnel can only confirm the outer labels, while the inner labels need to be checked one by one by the personnel opening the barrier bag.

Therefore, how to propose a package process monitoring system and a method of monitoring the packaging process that can improve the efficiency of packaging process is one of the problems that the industry urgently wants to invest in research and development resources to solve.

### SUMMARY

In view of this, one purpose of the present disclosure is to provide a package process monitoring system and a method of monitoring the packaging process can solve the aforementioned problems.

In order to achieve the above objective, according to an embodiment of the present disclosure, a method of monitoring a packaging process includes: placing a material into a material box; printing a barcode on a first tag and a second tag; posting the first tag on the material box; capturing a first image of the first tag including the barcode; packaging the material box by a barrier bag; posting the second tag on the barrier bag; capturing a second image of the second tag including the barcode; identifying the first image and the second image; and issuing an alarm if at least one of the first image and the second image is identified as unreadable.

In one or more embodiments of the present disclosure, wherein identifying the first image and the second image further includes: identifying whether the first image and the second image conform to a reference text; identifying whether the first image and the second image conform to a reference format; and determining whether a clarity of the first image and a clarity of the second image are greater than a clarity of a reference image.

In one or more embodiments of the present disclosure, issuing the alarm if at least one of the first image and the second image is identified as unreadable further includes at least one of: determining the material box corresponded to the first image and the second image is an error product and issuing the alarm if at least one of the first image and the second image does not conform to the reference text; determining the material box corresponded to the first image and the second image is the error product and issuing the alarm if at least one of the first image and the second image does not conform to the reference format; and determining the material box corresponded to the first image and the second image is the error product and issuing the alarm if at least one of the clarity of the first image and the clarity of the second image is greater than the clarity of the reference image.

In one or more embodiments of the present disclosure, identifying the first image and the second image further includes: identifying whether the barcode of the first image and the barcode of the second image is readable.

In one or more embodiments of the present disclosure, capturing the first image of the first tag including the barcode is performed before posting the second tag on the barrier bag.

In one or more embodiments of the present disclosure, capturing the second image of the second tag including the barcode is performed after capturing the first image of the first tag including the barcode.

In one or more embodiments of the present disclosure, capturing the first image of the first tag including the barcode is performed before packaging the material box by the barrier bag.

In one or more embodiments of the present disclosure, issuing the alarm if at least one of the first image and the second image is identified as unreadable further includes: sending an error email; and sending an error code of an error product to a server.

In order to achieve the above objective, according to an embodiment of the present disclosure, a method of monitoring a packaging process includes: placing a material into a material box; packaging the material box by a barrier bag; posting a first tag and a second tag on the material box and the barrier bag, respectively; capturing a first image of the first tag including a barcode and a second image of the second tag including the barcode; posting a blank RFID tag on the material box; identifying the first image and the second image; and issuing an alarm if at least one of the first image and the second image is identified as unreadable.

In one or more embodiments of the present disclosure, identifying the first image and the second image further includes: identifying whether the first image and the second image conform to a reference text; identifying whether the first image and the second image conform to a reference format; and determining whether a clarity of the first image and a clarity of the second image are greater than a clarity of a reference image.

In one or more embodiments of the present disclosure, issuing the alarm if at least one of the first image and the second image is identified as unreadable further comprises at least one of: determining the material box corresponded to the first image and the second image is an error product and issuing the alarm if at least one of the first image and the second image does not conform to the reference text; determining the material box corresponded to the first image and the second image is the error product and issuing the alarm if at least one of the first image and the second image does not conform to the reference format; and determining the material box corresponded to the first image and the second image is the error product and issuing the alarm if at least one of the clarity of the first image and the clarity of the second image is greater than the clarity of the reference image.

In one or more embodiments of the present disclosure, identifying the first image and the second image further includes: identifying whether the barcode of the first image and the barcode of the second image is readable.

In one or more embodiments of the present disclosure, capturing the first image of the first tag including the barcode is performed before posting the second tag on the barrier bag.

In one or more embodiments of the present disclosure, capturing the second image of the second tag including the barcode is performed after capturing the first image of the first tag including the barcode.

In one or more embodiments of the present disclosure, capturing the first image of the first tag including the barcode is performed before packaging the material box by the barrier bag.

In one or more embodiments of the present disclosure, issuing the alarm if at least one of the first image and the second image is identified as unreadable further includes: sending an error email; and sending an error code of an error product to a server.

In order to achieve the above objective, according to an embodiment of the present disclosure, a packaging process monitoring system includes a packaging device, a printing device, a labelling device, an image capturing device, and a server. The packaging device is configured to package a material box by a barrier bag. The printing device is configured to print a barcode on a first tag and a second tag. The labelling device is connected to the packaging device and the printing device. The labelling device is configured to post the first tag and the second tag on the material box and the barrier bag, respectively. The image capturing device is configured to capture a first image of the first tag including the barcode and a second image of the second tag including the barcode. The server is electrically and communicatively connected to the packaging device, the printing device, the labelling device, and the image capturing device. The server is configured to: identify the first image and the second image; and issue an alarm if at least one of the first image and the second image is identified as unreadable.

In one or more embodiments of the present disclosure, the labelling device is further configured to: post a blank RFID tag on the material box.

In one or more embodiments of the present disclosure, the server is further configured to: identify whether the first image and the second image conform to a reference text; identify whether the first image and the second image conform to a reference format; and determine whether a clarity of the first image and a clarity of the second image are greater than a clarity of a reference image.

In one or more embodiments of the present disclosure, the server is further configured to perform at least one of: determine the material box corresponded to the first image and the second image is an error product and issue the alarm if at least one of the first image and the second image does not conform to the reference text; determine the material box corresponded to the first image and the second image is the error product and issue the alarm if at least one of the first image and the second image does not conform to the reference format; and determine the material box corresponded to the first image and the second image is the error product and issue the alarm if at least one of the clarity of the first image and the clarity of the second image is greater than the clarity of the reference image.

In summary, in the packaging process monitoring system and the method of monitoring the packaging process of the present disclosure, since the method includes identifying the first image and the second image, the packaging process monitoring system can effectively manage the condition of the first tag and the second tag of the material box. In the packaging process monitoring system and the method of monitoring the packaging process of the present disclosure, since capturing the first image of the first tag including the barcode is performed before packaging the material box by the barrier bag, the first image of the first tag can be captured for identification before the material box is sealed, thereby eliminating the step of detaching the barrier bags from the error products to check the first tags one by one. In the packaging process monitoring system and the method of monitoring the packaging process of the present disclosure, since the image capturing device can capture the images of the first tag and the second tag, the cost of personnel used to manually inspect the products can be reduced. In the packaging process monitoring system and the method of monitoring the packaging process of the present disclosure, since the method includes identifying the conformity of texts, patterns, and formats among the first tag, the second tag, and the reference, the probability that the barcode on the tags cannot be read by the client's apparatus will be greatly decreased. Overall, the packaging process monitoring system and the method of monitoring the packaging process of the present disclosure not only improves the efficiency of the packaging process but also avoids huge losses caused by products with error labels being returned after being shipped to the clients.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a functional block diagram of a packaging process monitoring system in accordance with an embodiment of the present disclosure;

FIG. 2 is a flow chart of a method of monitoring a packaging process in accordance with an embodiment of the present disclosure;

FIG. 3 is a schematic view of a material box placed with wafers in accordance with an embodiment of the present disclosure;

FIG. 4 is a schematic view of the material box placed with the wafers of FIG. 3 is packaged by a barrier bag in accordance with an embodiment of the present disclosure;

FIG. 5 is a schematic view of a first tag or a second tag in accordance with an embodiment of the present disclosure;

FIG. 6 is a schematic view of identifying whether the first image and the second image conform to a reference text in accordance with an embodiment of the present disclosure;

FIG. 7 is a schematic view of identifying whether the first image and the second image conform to a reference format in accordance with an embodiment of the present disclosure; and

FIG. 8 is a schematic view of determining whether a clarity of the first image and a clarity of the second image are greater than a clarity of a reference image in accordance with an embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The system may be otherwise oriented (rotated 90 degrees or at other orientations) and the spatially relative descriptors used herein may likewise be interpreted accordingly.

As used herein, “around,” “about,” “approximately,” or “substantially” shall generally mean within 20 percent, or within 10 percent, or within 5 percent of a given value or range. Numerical quantities given herein are approximate, meaning that the term “around,” “about,” “approximately,” or “substantially” can be inferred if not expressly stated.

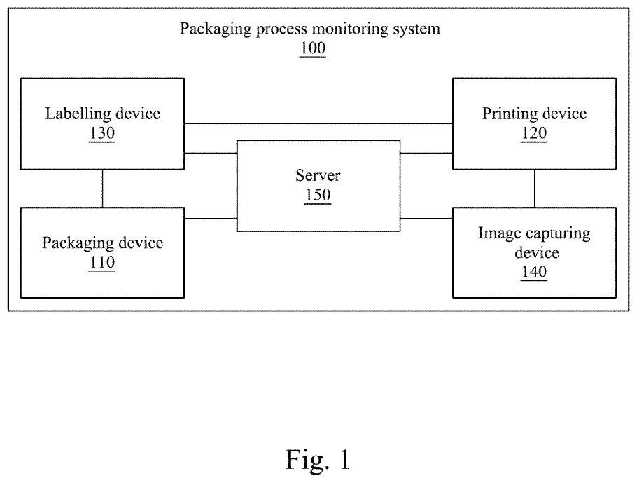

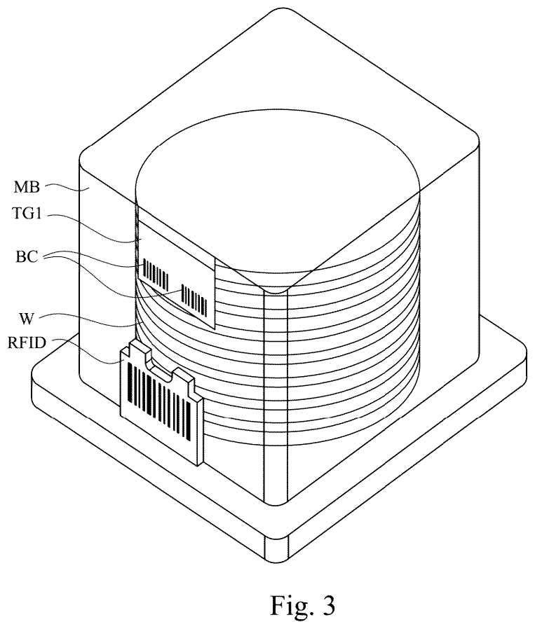

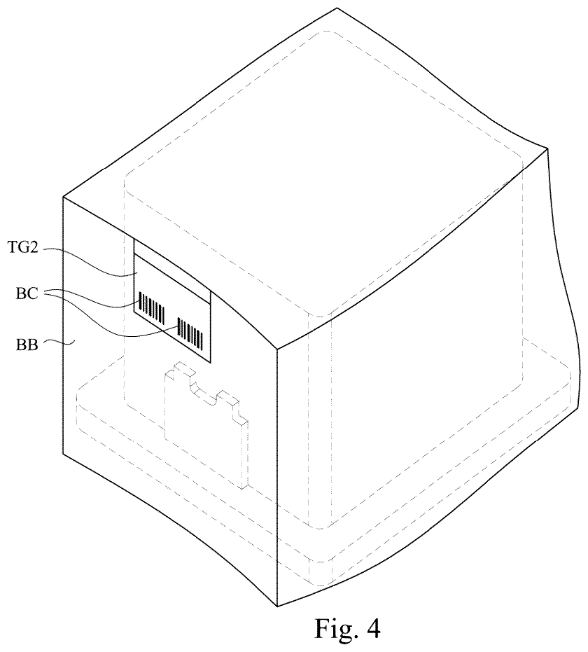

Reference is made to FIG. 1. FIG. 1 is a functional block diagram of a packaging process monitoring system 100 in accordance with an embodiment of the present disclosure. In this embodiment, the packaging process monitoring system 100 includes a packaging device 110, a printing device 120, a labelling device 130, an image capturing device 140, and a server 150. The packaging device 110 is connected to the labelling device 130 and the server 150. The packaging device 110 is configured to place at least one material into a material box MB (as shown in FIG. 3). The packaging device 110 is configured to package the material box MB. The printing device 120 is connected to labelling device 130, the image capturing device 140, and the server 150. The printing device 120 is configured to print a barcode BC on a first tag TG1 and a second tag TG2 (as shown in FIG. 3 and FIG. 4). The labelling device 130 is connected to the packaging device 110, the printing device 120, and the server 150. The labelling device 130 is configured to post the first tag TG1 and the second tag TG2 on the material box MB and a barrier bag BB (as shown in FIG. 3 and FIG. 4), respectively. The image capturing device 140 is connected to the printing device 120 and the server 150. The image capturing device 140 is configured to capture a first image of the first tag TG1 including the barcode BC and the second tag TG2 including the barcode BC. The server 150 is electrically and communicatively connected to the packaging device 110, the printing device 120, the labelling device 130, and the image capturing device 140. The server 150 is configured to identify the first image and the second image. The server 150 is further configured to issue an alarm if at least one of the first image and the second image is identified as unreadable.

In some embodiments, the packaging device 110 may be auto-packing system (APK) or other suitable device. The present disclosure is not intended to limit the type of the packaging device 110.

In some embodiments, the printing device 120 may be barcode printer, label printer or other suitable device. The present disclosure is not intended to limit the type of the printing device 120.

In some embodiments, the labelling device 130 may be automatic labelling machine or other suitable device. The present disclosure is not intended to limit the type of the labelling device 130.

In some embodiments, the image capturing device 140 may be camera or other suitable device. The present disclosure is not intended to limit the type of the image capturing device 140.

In some embodiments, the server 150 may be artificial intelligence (AI) module at least with the functions of deep learning, image recognition, object detection, or the like. The present disclosure is not intended to limit the type of the server 150.

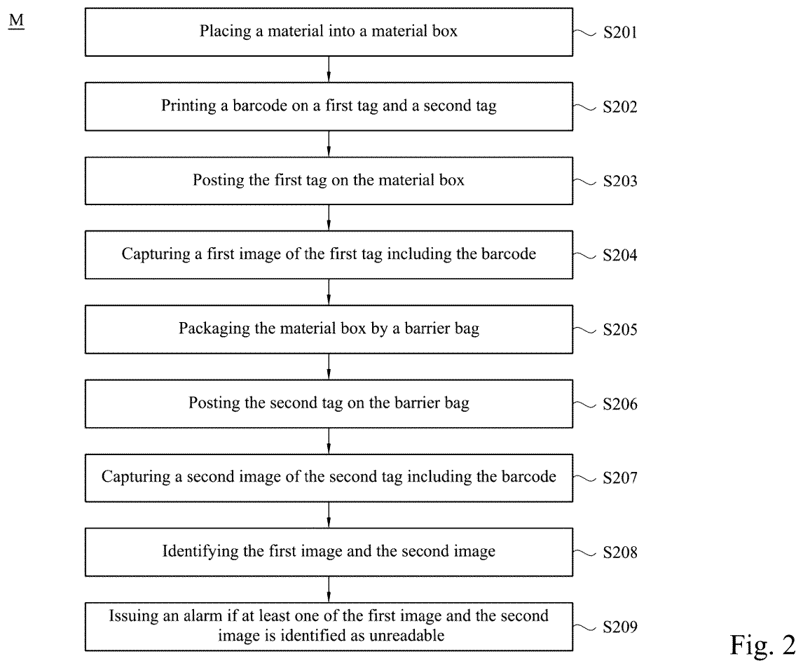

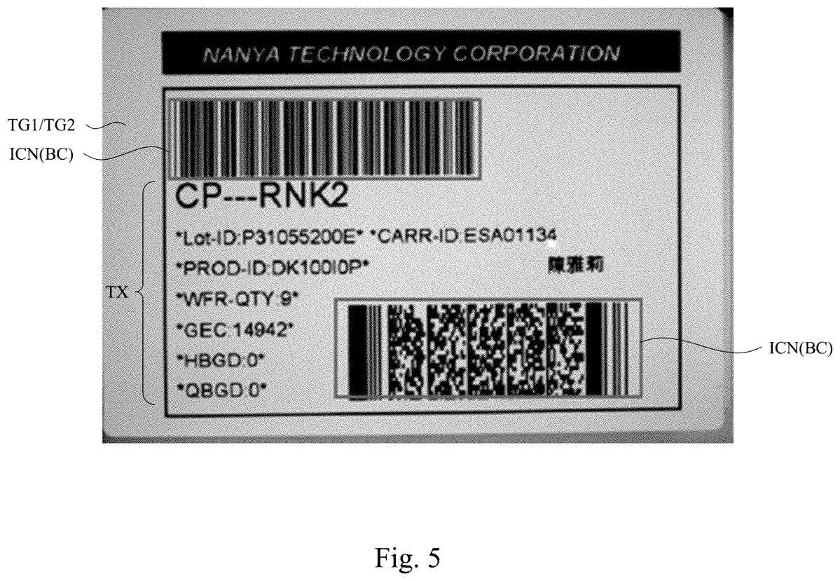

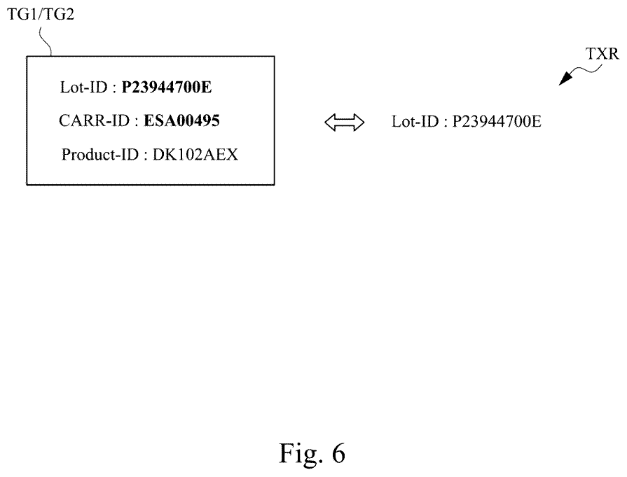

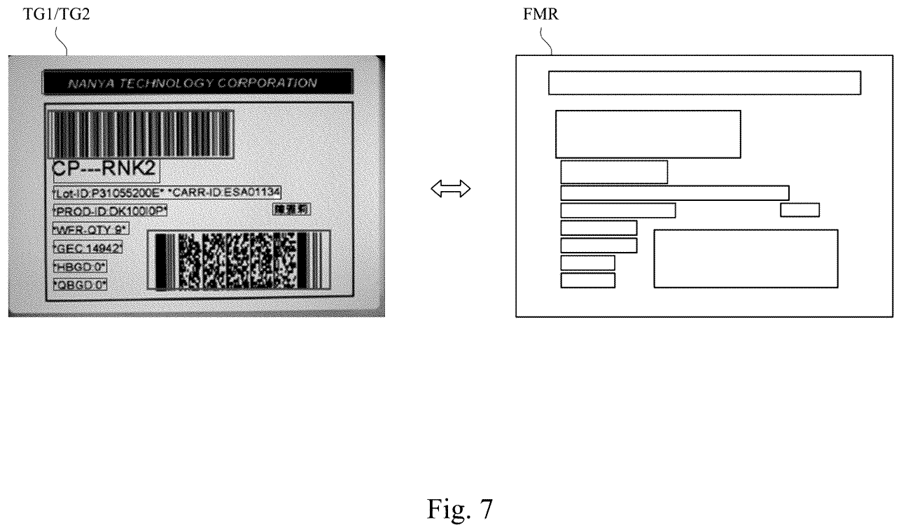

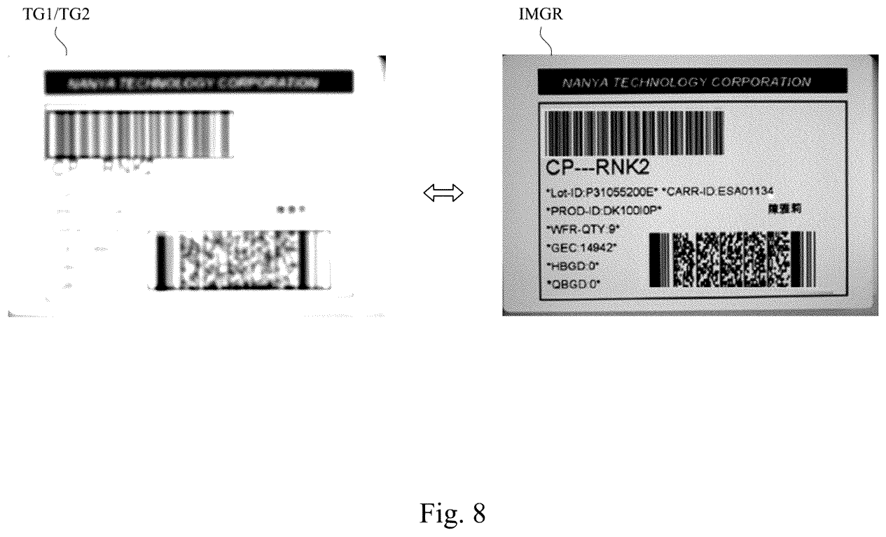

Reference is made to FIG. 2. FIG. 2 is a flow chart of a method of monitoring a packaging process in accordance with an embodiment of the present disclosure. The packaging process is monitored by the packaging process monitoring system as shown in FIG. 1. The method M shown in FIG. 2 includes a step S201, a step S202, a step S203, a step S204, a step S205, a step S206, a step S207, a step S208, and a step S209. Please refer to FIG. 2 and FIG. 3 for better understanding the step S201. Please refer to FIG. 2, FIG. 3, and FIG. 4 for better understanding the step S202. Please refer to FIG. 2 and FIG. 3 for better understanding the step S203. Please refer to FIG. 2 and FIG. 5 for better understanding the step S204. Please refer to FIG. 2 and FIG. 4 for better understanding the step S205. Please refer to FIG. 2 and FIG. 4 for better understanding the step S206. Please refer to FIG. 2 and FIG. 5 for better understanding the step S207. Please refer to FIG. 2, FIG. 5, FIG. 6, FIG. 7, and FIG. 8 for better understanding the step S208. Please refer to FIG. 2, FIG. 6, FIG. 7, and FIG. 8 for better understanding the step S209.

Step S201, step S202, step S203, step S204, step S205, step S206, step S207, step S208, and step S209 are described in detail below.

Step S201: Placing a material into a material box MB.

Reference is made to FIG. 3. FIG. 3 is schematic view of a material box MB placed with wafers W in accordance with an embodiment of the present disclosure. In this embodiment, the material is placed into the material box MB. In some embodiments, the material may be the wafers W, as shown in FIG. 3. More specifically, the packaging device 110 places the wafers W into the material box MB.

In some embodiments, the material box MB may be front opening shipping box (FOSB). In some other embodiments, the material box MB may be front opening unified pod (FOUP) or other suitable container.

Step S202: Printing a barcode BC on a first tag TG1 and a second tag TG2.

Reference is made to FIG. 3 and FIG. 4. FIG. 4 is schematic view of the material box MB placed with the wafers W of FIG. 3 is packaged by a barrier bag BB in accordance with an embodiment of the present disclosure. As shown in FIG. 3 and FIG. 4, in this embodiment, the barcode BC is printed on the first tag TG1 and the second tag TG2. Each of the first tag TG1 and the second tag TG2 may include a plurality of barcodes BC printed thereon. More specifically, the printing device 120 prints one or more barcodes BC on each of the first tag TG1 and the second tag TG2.

In some embodiments, the step of printing the barcode BC on the first tag TG1 and the second tag TG2 (i.e., step S202) is performed after the step of placing the material into a material box MB (i.e., step S201).

In a usage scenario, after the packaging device 110 places the wafers W into the material box MB, the printing device 120 prints the barcode BC on the first tag TG1 and the second tag TG2.

Step S203: Posting the first tag TG1 on the material box MB.

Reference is made again to FIG. 3. In this embodiment, the first tag TG1 is posted on the material box MB. Specifically, the first tag TG1 is posted on an outer surface of the material box MB. As shown in FIG. 3, the first tag TG1 printed with the barcode BC is posted on the material box MB. More specifically, the labelling device 130 posts the first tag TG1 on the material box MB.

In some embodiments, the step of posting the first tag TG1 on the material box MB (i.e., step S203) is performed after the step of printing the barcode BC on the first tag TG1 and the second tag TG2 (i.e., step S202).

In a usage scenario, after the printing device 120 prints the barcode BC on the first tag TG1 and the second tag TG2, the labelling device 130 posts the first tag TG1 on the material box MB.

In some embodiments, the method M further includes posting a blank RFID tag on the material box MB. After performing the step S203, the labelling device 130 posts the blank RFID tag on the material box MB. As shown in FIG. 3, in some embodiments, a previous electronic tag RFID is attached on the material box MB. Hence, the labelling device 130 removes the previous electronic tag RFID from the material box MB and posts the blank RFID tag on the material box MB without any barcode.

Step S204: Capturing a first image of the first tag TG1 including the barcode BC.

Reference is made to FIG. 5. FIG. 5 is a schematic view of the first tag TG1 or the second tag TG2 in accordance with an embodiment of the present disclosure. As shown in FIG. 5, in this embodiment, the first image of the first tag TG1 is captured. More specifically, the image capturing device 140 captures the first image of the first tag TG1. As shown in FIG. 5, the first image of the first tag TG1 includes a text portion TX and a pattern portion ICN. In some embodiments, the text portion TX includes a lot number, a product number, product quantity information, and client information. The text portion TX at least provides the information of where the wafers W are processed, the identification of the wafers W, the quantity of the wafers W, and the where the wafers W are shipped to. The pattern portion ICN includes the one or more barcodes BC as mentioned above. The barcode BC at least contains the information shown in the text portion TX. In other words, the image capturing device 140 captures the text portion TX and the pattern portion ICN of the first image of the first tag TG1.

In some embodiments, the step of capturing the first image of the first tag TG1 including the barcode BC (i.e., step S204) is performed after the step of posting the first tag TG1 on the material box MB (i.e., step S203).

In a usage scenario, after the labelling device 130 posts the first tag TG1 on the material box MB, the image capturing device 140 captures the first image of the first tag TG1 including the barcode BC of the pattern portion ICN and texts of the text portion TX.

Step S205: Packaging the material box MB by a barrier bag BB.

Reference is made again to FIG. 4. As shown in FIG. 4, in this embodiment, the material box MB is packaged by the barrier bag BB. The material box MB accommodates the wafers W as shown in FIG. 3. More specifically, the packaging device 110 packages the material box MB by the barrier bag BB. The barrier bag BB wraps the material box MB placed with the wafers W.

In some embodiments, the barrier bag BB may be a moisture barrier bag, an aluminum bag, an antistatic bag, a transparent bag, or the like. The present disclosure is not intended to limit the type of the barrier bag BB.

In some embodiments, the step of capturing the first image of the first tag TG1 including the barcode BC (i.e., step S204) is performed before the step of packaging the material box MB by a barrier bag BB (i.e., step S205).

In a usage scenario, after the image capturing device 140 captures the first image of the first tag TG1 including the barcode BC, the packaging device 110 packages the material box MB by the barrier bag BB.

Step S206: Posting the second tag TG2 on the barrier bag BB.

Reference is made to FIG. 4. In this embodiment, the second tag TG2 is posted on the barrier bag BB. Specifically, the second tag TG2 is posted on an outer surface of the barrier bag BB. As shown in FIG. 4, the second tag TG2 printed with the barcode BC is posted on the material box MB. More specifically, the labelling device 130 posts the second tag TG2 on the material box MB.

In some embodiments, a quantity of the first tag TG1 and a quantity of the second tag TG2 may be plural. In some embodiments, the quantity of the first tag TG1 and the quantity of the second tag TG2 may be identical. The present disclosure is not intended to limit the quantity of the first tag TG1 and the quantity of the second tag TG2.

In some embodiments, the step of posting the second tag TG2 on the barrier bag BB (i.e., step S206) is performed after the step of packaging the material box MB by the barrier bag BB (i.e., step S205). In some embodiments, the step of capturing the first image of the first tag TG1 including the barcode BC (i.e., step S204) is performed before the step of posting the second tag TG2 on the barrier bag BB (i.e., step S206).

In a usage scenario, after the packaging device 110 packages the material box MB by the barrier bag BB, the labelling device 130 posts the second tag TG2 on the barrier bag BB.

Step S207: Capturing a second image of the second tag TG2 including the barcode BC.

Reference is made again to FIG. 5. In this embodiment, the second image of the second tag TG2 is captured. More specifically, the image capturing device 140 captures the second image of the second tag TG2. As shown in FIG. 5, the second image of the second tag TG2 also includes the text portion TX and the pattern portion ICN as shown in the first image of the first tag TG1. In other words, the image capturing device 140 captures the text portion TX and the pattern portion ICN of the second image of the second tag TG2.

In some embodiments, the step of capturing the second image of the second tag TG2 including the barcode BC (i.e., step S207) is performed after the step of posting the second tag TG2 on the barrier bag BB (i.e., step S206). In some embodiments, the step of capturing the second image of the second tag TG2 including the barcode BC (i.e., step S207) is performed after the step of capturing the first image of the first tag TG1 including the barcode BC (i.e., step S204).

In a usage scenario, after the labelling device 130 posts the second tag TG2 on the barrier bag BB, the image capturing device 140 captures the second image of the second tag TG2 including the barcode BC of the pattern portion ICN and texts of the text portion TX.

Step S208: Identifying the first image and the second image.

Reference is made to FIG. 6, FIG. 7, and FIG. 8. FIG. 6 is a schematic view of identifying whether the first image and the second image conform to a reference text TXR in accordance with an embodiment of the present disclosure. FIG. 7 is a schematic view of identifying whether the first image and the second image conform to a reference format FMR in accordance with an embodiment of the present disclosure. FIG. 8 is a schematic view of determining whether a clarity of the first image and a clarity of the second image are greater than a clarity of a reference image IMGR in accordance with an embodiment of the present disclosure. In this embodiment, the first image and the second image are identified. More specifically, the server 150 identifies the first image of the first tag TG1 and the second image TG2. As shown in FIG. 5, the server 150 identifies whether the pattern portion ICN of the first image and the pattern portion ICN of the second image is readable. For instance, the server 150 substantially identifies the barcode BC of the first image and the barcode BC of the second image. This ensures that the client may further be able to utilize the material box MB with available (i.e., readable) barcode BC.

In some embodiments, the server 150 may identify the text portion TX of the first image of the first tag TG1 and the text portion TX of the second image of the second tag TG2 by applying optical character recognition (OCR) or other suitable technologies. The present disclosure is not intended to limit the method of identifying the first image and the second image.

As shown in FIG. 6, the server 150 identifies whether both the first image and the second image conform to the reference text TXR. More specifically, the server 150 may record the information of the wafers W previously, and the information of the wafers W may then be stored in the server 150 as a reference data (e.g., the reference text TXR). In a usage scenario, the server 150 determines whether the lot number (i.e., “Lot-ID” depicted in FIG. 6) included in the reference text TXR is identical to the lot number printed on the first tag TG1 and the second tag TG2, as shown in FIG. 6.

As shown in FIG. 7, the server 150 identifies whether both the first image and the second image conform to the reference format FMR. More specifically, the server 150 may record a format of the first TG1 and the second tag TG2 previously, and the format of the first TG1 and the second tag TG2 may then be stored in the server 150 as a reference data (e.g., the reference format FMR). In a usage scenario, the server 150 determines whether a layout (i.e., rectangular blocks depicted in FIG. 7) of the reference format FMR is identical to a layout of the first tag TG1 and the second tag TG2, as shown in FIG. 7.

As shown in FIG. 8, the server 150 determines whether both a clarity of the first image and a clarity of the second image are greater than a clarity of a reference image IMGR. More specifically, the server 150 may record the image of historical tags captured by the image capturing device 140 previously, and the image of the historical tags may then be stored in the server 150 as a reference data. Of course, the image of the historical tags at least has a resolution higher than a lowest limit to be recognized by the server 150. In addition, the server 150 also calculates the resolution of the image of the historical tags. In a usage scenario, the server 150 determines whether the resolution of the first image and the resolution of the second image are equal or greater than the resolution of the reference image IMGR, as shown in FIG. 8.

In some embodiments, the step of identifying the first image and the second image (i.e., step S208) is performed after the step of capturing the second image of the second tag TG2 including the barcode BC (i.e., step S207).

In a usage scenario, after the image capturing device 140 captures the second image of the second tag TG2 including the barcode BC, the server 150 identifies the first image and the second image.

Step S209: Issuing an alarm if at least one of the first image and the second image is identified as unreadable.

Reference is made again to FIG. 6, FIG. 7, and FIG. 8. In this embodiment, if at least one of the first image and the second image is identified as unreadable, the alarm is issued accordingly. More specifically, the server 150 issues the alarm if at least one of the first image and the second image is identified as unreadable. In other words, the alarm will be issued if at least one of the following conditions is met: the first image and the second image are both identified as unreadable; the first image is readable, whereas the second image is unreadable; and the first image is unreadable, whereas the second image is readable. Otherwise, If the first image and the second image are both identified as readable, the alarm will not be issued.

As shown in FIG. 6, the server 150 determines the material box MB corresponded to the first image and the second image is an error product and issuing the alarm if at least one of the first image and the second image does not conform to the reference text TXR. In other words, if at least one of the first image and the second image does not conform to the reference text TXR, the server 150 will not only determine the material box MB placed with the wafers W is the error product but also issue the alarm.

As shown in FIG. 7, the server 150 determines the material box corresponded to the first image and the second image is the error product and issuing the alarm if at least one of the first image and the second image does not conform to the reference format FMR. In other words, if at least one of the first image and the second image does not conform to the reference format FMR, the server 150 will not only determine the material box MB placed with the wafers W is the error product but also issue the alarm.

As shown in FIG. 8, the server 150 determines the material box corresponded to the first image and the second image is the error product and issuing the alarm if at least one of the clarity of the first image and the clarity of the second image is greater than the clarity of the reference image IMGR. In other words, if at least one of the clarity of the first image and the clarity of the second image is greater than the clarity of the reference image IMGR, the server 150 will not only determine the material box MB placed with the wafers W is the error product but also issue the alarm.

Overall, the material box MB will be determined as the error product if at least one of the following conditions is met: if at least one of the first image and the second image does not conform to the reference text TXR; if at least one of the first image and the second image does not conform to the reference format FMR; and if at least one of the clarity of the first image and the clarity of the second image is greater than the clarity of the reference image IMGR.

In some embodiments, issuing the alarm if at least one of the first image and the second image is identified as unreadable further includes sending an error email. For instance, the error email is sent to a user of the packaging process monitoring system 100 (e.g., a technical assistant (TA), an operator, a manager, a gatekeeper, or the like).

In some embodiments, issuing the alarm if at least one of the first image and the second image is identified as unreadable further includes sending an error code of the error product to the server 150. For instance, the server 150 may record the error code of the error product, so that the user of the packaging process monitoring system 100 can find out and take away the error product from the end of the production line, thereby avoiding the error product to be shipped to the client.

In some embodiments, the step of issuing the alarm if at least one of the first image and the second image is identified as unreadable (i.e., step S209) is performed after the step of identifying the first image and the second image (i.e., step S208).

In a usage scenario, after the server 150 identifies the first image and the second image, the server 150 will issue the alarm if at least one of the first image and the second image is identified as unreadable.

In some embodiments, the method M may be implemented by sequentially performing step S201, step S202, step S203, step S206, step S204, step S207, step S205, step S208, and step S209. That is, the labelling device 130 respectively posts the first tag TG1 and the second tag TG2 on the material box MB and the barrier bag BB, the image capturing device 140 then captures the first image and the second image. Next, the server 150 finally identifies the first image and the second image.

By performing the method M shown in FIG. 2 of the present disclosure, the packaging process monitoring system 100 can monitor the packaging process and find out the error product in the production line.

Based on the above discussions, it can be seen that in the packaging process monitoring system and the method of monitoring the packaging process of the present disclosure, since the method includes identifying the first image and the second image, the packaging process monitoring system can effectively manage the condition of the first tag and the second tag of the material box. In the packaging process monitoring system and the method of monitoring the packaging process of the present disclosure, since capturing the first image of the first tag including the barcode is performed before packaging the material box by the barrier bag, the first image of the first tag can be captured for identification before the material box is sealed, thereby eliminating the step of detaching the barrier bags from the error products to check the first tags one by one. In the packaging process monitoring system and the method of monitoring the packaging process of the present disclosure, since the image capturing device can capture the images of the first tag and the second tag, the cost of personnel used to manually inspect the products can be reduced. In the packaging process monitoring system and the method of monitoring the packaging process of the present disclosure, since the method includes identifying the conformity of texts, patterns, and formats among the first tag, the second tag, and the reference, the probability that the barcode on the tags cannot be read by the client's apparatus will be greatly decreased. Overall, the packaging process monitoring system and the method of monitoring the packaging process of the present disclosure not only improves the efficiency of the packaging process but also avoids huge losses caused by products with error labels being returned after being shipped to the clients.

In some embodiments, the server 150 of the packaging process monitoring system 100 of the present disclosure can be applied in artificial intelligence (AI) computing and edge computing.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method of monitoring a packaging process, comprising:
placing a material into a material box;
printing a barcode on a first tag and a second tag;
posting the first tag on the material box;
capturing a first image of the first tag including the barcode;
packaging the material box by a barrier bag;
posting the second tag on the barrier bag;
capturing a second image of the second tag including the barcode;
identifying the first image and the second image; and
issuing an alarm if at least one of the first image and the second image is identified as unreadable.

2. The method of claim 1, wherein identifying the first image and the second image further comprises:
identifying whether the first image and the second image conform to a reference text;
identifying whether the first image and the second image conform to a reference format; and
determining whether a clarity of the first image and a clarity of the second image are greater than a clarity of a reference image.

3. The method of claim 2, wherein issuing the alarm if at least one of the first image and the second image is identified as unreadable further comprises at least one of:
determining the material box corresponded to the first image and the second image is an error product and issuing the alarm if at least one of the first image and the second image does not conform to the reference text;
determining the material box corresponded to the first image and the second image is the error product and issuing the alarm if at least one of the first image and the second image does not conform to the reference format; and
determining the material box corresponded to the first image and the second image is the error product and issuing the alarm if at least one of the clarity of the first image and the clarity of the second image is greater than the clarity of the reference image.

4. The method of claim 1, wherein identifying the first image and the second image further comprises:
identifying whether the barcode of the first image and the barcode of the second image is readable.

5. The method of claim 1, wherein capturing the first image of the first tag including the barcode is performed before posting the second tag on the barrier bag.

6. The method of claim 1, wherein capturing the second image of the second tag including the barcode is performed after capturing the first image of the first tag including the barcode.

7. The method of claim 1, wherein capturing the first image of the first tag including the barcode is performed before packaging the material box by the barrier bag.

8. The method of claim 1, wherein issuing the alarm if at least one of the first image and the second image is identified as unreadable further comprises:
sending an error email; and
sending an error code of an error product to a server.

9. A method of monitoring a packaging process, comprising:
placing a material into a material box;
packaging the material box by a barrier bag;
posting a first tag and a second tag on the material box and the barrier bag, respectively;
capturing a first image of the first tag including a barcode and a second image of the second tag including the barcode;
posting a blank RFID tag on the material box;
identifying the first image and the second image; and
issuing an alarm if at least one of the first image and the second image is identified as unreadable.

10. The method of claim 9, wherein identifying the first image and the second image further comprises:
identifying whether the first image and the second image conform to a reference text;
identifying whether the first image and the second image conform to a reference format; and
determining whether a clarity of the first image and a clarity of the second image are greater than a clarity of a reference image.

11. The method of claim 10, wherein issuing the alarm if at least one of the first image and the second image is identified as unreadable further comprises at least one of:
determining the material box corresponded to the first image and the second image is an error product and issuing the alarm if at least one of the first image and the second image does not conform to the reference text;
determining the material box corresponded to the first image and the second image is the error product and issuing the alarm if at least one of the first image and the second image does not conform to the reference format; and
determining the material box corresponded to the first image and the second image is the error product and issuing the alarm if at least one of the clarity of the first image and the clarity of the second image is greater than the clarity of the reference image.

12. The method of claim 9, wherein identifying the first image and the second image further comprises:
identifying whether the barcode of the first image and the barcode of the second image is readable.

13. The method of claim 9, wherein capturing the first image of the first tag including the barcode is performed before posting the second tag on the barrier bag.

14. The method of claim 9, wherein capturing the second image of the second tag including the barcode is performed after capturing the first image of the first tag including the barcode.

15. The method of claim 9, wherein capturing the first image of the first tag including the barcode is performed before packaging the material box by the barrier bag.

16. The method of claim 9, wherein issuing the alarm if at least one of the first image and the second image is identified as unreadable further comprises:
sending an error email; and
sending an error code of an error product to a server.

17. A packaging process monitoring system, comprising:
a packaging device configured to package a material box by a barrier bag;
a printing device configured to print a barcode on a first tag and a second tag;
a labelling device connected to the packaging device and the printing device and configured to post the first tag and the second tag on the material box and the barrier bag, respectively;
an image capturing device configured to capture a first image of the first tag including the barcode and a second image of the second tag including the barcode; and
a server electrically and communicatively connected to the packaging device, the printing device, the labelling device, and the image capturing device, wherein the server is configured to:
identify the first image and the second image; and
issue an alarm if at least one of the first image and the second image is identified as unreadable.

18. The packaging process monitoring system of claim 17, wherein the labelling device is further configured to:
post a blank RFID tag on the material box.

19. The packaging process monitoring system of claim 17, wherein the server is further configured to:
identify whether the first image and the second image conform to a reference text;
identify whether the first image and the second image conform to a reference format; and
determine whether a clarity of the first image and a clarity of the second image are greater than a clarity of a reference image.

20. The packaging process monitoring system of claim 19, wherein the server is further configured to perform at least one of:
determine the material box corresponded to the first image and the second image is an error product and issue the alarm if at least one of the first image and the second image does not conform to the reference text;
determine the material box corresponded to the first image and the second image is the error product and issue the alarm if at least one of the first image and the second image does not conform to the reference format; and
determine the material box corresponded to the first image and the second image is the error product and issue the alarm if at least one of the clarity of the first image and the clarity of the second image is greater than the clarity of the reference image.
